(19) United States
(12) Patent Application Publication
(10) Pub. No.: US 2023/0296419 A1
(43) Pub. Date: Sep. 21, 2023

(54) AUTOMATION FIELD DEVICE

(71) Applicant: Endress+Hauser Flowtec AG, Reinach (CH)

(72) Inventors: Florent Tschambser, Hesingue (FR); Lars Dreher, Ballrechten Dottingen (DE); Werner Wohlgemuth, Seewen (CH); Timothy-James Hug, Seuzach (CH); Thomas Sulzer, Basel (CH)

(21) Appl. No.: 18/040,473

(22) PCT Filed: Jul. 16, 2021
(86) PCT No.: PCT/EP2021/069936

§ 371 Date: Feb. 3, 2023

(30) Foreign Application Priority Data
Aug. 4, 2020 (DE) 10 2020 120 592.9

(51) Int. Cl. G01F 15/14; G01F 1/58; C08K 5/00

(52) U.S. Cl. CPC G01F 15/14; C08K 5/0091; G01F 1/588

(57) ABSTRACT

The present disclosure relates to a process automation field device, comprising: a container for receiving and/or conducting a medium, the container having an outer surface; a measuring apparatus for determining a process variable of the medium; electronic components for operating the measuring apparatus; and a housing including a housing body, wherein: the measuring apparatus and the electronic components are disposed in the housing; the housing body is disposed on the outer surface; the housing body comprises a composite material; the measuring apparatus and the electronic components are at least partly surrounded by the composite material; and the composite material comprises a polymer matrix and an additive, which comprises at least one chemical compound including an oxidized transition metal from the fourth group of the periodic table. The present disclosure also relates to a method for producing the field device and to use of the additive to improve adhesion.

The invention relates to an automation field device, a method for producing a housing of the automation field device and a use of an additive to improve adhesion.

In automation, particularly in process automation, field devices serving to capture and/or modify process variables are frequently used. For detecting process variables, sensors that are integrated, for example, into fill level measuring devices, flow meters, pressure and temperature measuring devices, pH-redox potential meters, conductivity meters, etc., are used to detect the respective process variables, such as fill level, flow, pressure, temperature, pH level or conductivity. Actuators, such as, for example, valves or pumps, are used to influence process variables. The flow rate of a fluid in a pipeline section or a filling level in a container can thus be altered by means of actuators. Field devices, in general, refer to all devices which are process-oriented and which supply or process process-relevant information. In connection with the invention, “field devices” therefore also refer to remote I/Os, radio adapters, or, in general, electronic measuring components that are disposed at the field level.

A field device is in particular selected from a group consisting of flow meters, fill level measuring devices, pressure measuring devices, temperature measuring devices, limit level measuring devices and/or analytical measuring devices.

Flow meters are, in particular, Coriolis, ultrasound, vortex, thermal and/or magnetic-inductive flow meters.

Level-measuring devices are, in particular, microwave level-measuring devices, ultrasonic level-measuring devices, time-domain reflectometry-measuring devices, radiometric level-measuring devices, capacitive level-measuring devices, inductive level-measuring devices and/or temperature-sensitive level-measuring devices.

Pressure-measuring devices are, in particular, absolute, relative, or differential-pressure devices.

Temperature-measuring devices are, in particular, measuring devices with thermocouples and/or temperature-dependent resistors.

Limit level-measuring devices are, in particular, vibronic limit level-measuring devices, ultrasonic limit level-measuring devices and/or capacitive limit level-measuring devices.

Analytical measuring devices are, in particular, pH sensors, conductivity sensors, oxygen and active oxygen sensors, (spectro)photometric sensors, and/or ion-selective electrodes.

Different variants of automation field devices are known, most variants of which have a housing for stabilizing and for protecting the electronic components and/or the measuring components from the environment. Field devices can be subject to particularly high temperature fluctuations due to the broad field of use. This leads to material expansions and shrinkage within the housing, which can lead to incorrect measurements or to the failure of electronic components.

A field device which has a plastic housing formed by two plastic molded parts welded to one another is known from DE 10 2012 110 665 A1. It is true that such a design continues to allow access to individual measuring components of the flow meter. However, it is disadvantageous in relation to the position fixing of the individual connecting cables.

DE 10 2014 105 569 B3 discloses a field device having a housing which is made at least partly of a thermoplastic material and thus encloses the measuring tube partial section and at least one further measuring component which is fastened to it in a fitting manner. Although this solution is cost-effective, because the entire housing comprises only a single shrink-fit hose, which ensures the fixing and stabilization, it is disadvantageous that the housing cannot be recycled after the shrink-fitting.

A field device is known from DE 10 347 878 A1, which has a housing body formed from a potting material and consisting of an epoxy resin or polyurethane. To apply the potting material, the measuring tube is encased with a potting mold, for example made of sheet metal, which is then filled with the potting material. After the curing of the potting material, the potting mold is removed, wherein it is in particular also reusable. This invention is disadvantageous in that there is no adhesion between the housing body and the measuring tube sufficient to meet the requirements of the IP68 protection class.

The invention is based on the object of providing an automation field device with improved adhesion between container and housing body.

In addition, the object of the invention is to provide a method for producing the automation field device with which an improved adhesion between the container and the housing body is achieved.

The objects are achieved by the field device according to claim 1, the method for production according to claim 9, and the use of a titanate and/or zirconate according to claim 15.

The automation field device according to the invention comprises:
a container for receiving and/or conducting a medium,
   wherein the container comprises an outer surface;
a measuring apparatus for determining a process variable of the medium;
electronic components for operating the measuring apparatus;
a housing for protecting the measuring apparatus and the electronic components,
   wherein the housing comprises a housing body,
   wherein the measuring apparatus and the electronic components are disposed in the housing,
   wherein the housing body is disposed on the outer surface of the container,
   wherein the housing body comprises a composite material at least in part,
   wherein the measuring apparatus and the electronic components are at least partly surrounded by the composite material,
   wherein the composite material comprises a polymer matrix,
   wherein the composite material comprises an additive,
   wherein the additive comprises at least one chemical compound having an oxidized transition metal, preferably of the 4th subgroup.

The technical advantage of this embodiment according to the invention is that the measuring component is fixed in a very good and permanently stationary manner and at the same time protected against external influences, such as moisture, dirt, vibrations etc., wherein all cavities that may exist between the measuring tube and the potting mold are filled. The production can be carried out very cost-effectively.

The additive in the polymer matrix brings about a chemical bonding between the housing body and the surface of the container. In addition, the additive has catalytic properties, so that a curing temperature of the polymer matrix can be selected to be smaller. This leads to a lower load on the container, the measuring apparatus and the electronic components.

The measuring apparatus is constituted of the components necessary for determining the process variables. A field device comprises at least one measuring apparatus. The measuring apparatus of a magnetic-inductive flow meter comprises a device for generating a magnetic field and a device for measuring an induced measurement voltage, i.e., measuring electrodes with the associated terminals and cables. For the monitoring of a further process variable, the fill level, a measured substance monitoring electrode is additionally used. Magnetic-inductive flow meters are known which have further measuring apparatuses, such as temperature sensors or pressure measuring transducers. The measuring apparatus of an ultrasonic flow meter comprises at least one ultrasound transmitter and an ultrasound receiver.

In a magnetic-inductive flow meter, in addition to embedding the device for generating the magnetic field, the fixing of the corresponding electrical supply lines and the electronic components, such as the operation, measurement and/or evaluation circuit, by the potting material is also possible. The supply lines are then kept free of vibration without great effort, thereby increasing the measurement accuracy and interference resistance.

Advantageous embodiment of the invention are the subject matter of the dependent claims.

One embodiment provides that the outer surface of the container comprises a polyolefin. Polyolefins are polymers produced from saturated hydrocarbons, in particular alkenes, such as ethylene, propylene, 1-butene or isobutene, by chain polymerization. The best-known representatives of this plastics group are polyethylene (PE), polypropylene (PP) and polymethylpentene (PMP). Industrially produced and used polyolefins are polyisobutylene (PIB) and polybutylene (PB, polybutene-1). High-density polyethylene (abbreviated to HDPE or PE-HD) is used for the production of containers, gasoline tanks, pipes and household goods. Polypropylene (PP), especially isotactic polypropylene, and polyethylene (PE), is used as packaging in the medical and food sectors, for fibers and pipes.

One embodiment provides that the container is a polyethylene pipe (PE pipe). Polyethylene pipes are pipes produced from polyethylene (PE), which are used primarily in pipeline systems for gas and water supply and waste water disposal. In addition, they are used in various industrial sectors. The most important properties are corrosion resistance, resistance to different chemicals, crack resistance, water supply, low weight and simple bonding techniques. Pipelines of cross-linked polyethylene (PEX) or polyethylene with increased temperature resistance (PE-RT) are used, which are designed for continuous operation with water at 10 bar pressure and 70° C. fluid temperature. Multi-layer composite pipes made of PEX and aluminum are also used and likewise fall under the scope of protection as PEX or PE-RT pipes.

One embodiment provides that the polymer matrix comprises at least one first component and one second component, wherein the first component comprises an isocyanate, wherein the second component comprises a polyol.

It has been found that the combination of the additive with a polyurethane leads to a favorable composite material, which is ideally suited as a housing body or as a filler for stabilizing the measuring apparatus and also for automated filling processes. In addition, the combination between polyurethane and additive results in a cold-casting system, which cures without thermal treatment or at least with only a minimal amount of thermal treatment.

One embodiment provides that the transition metal is selected from the group comprising titanium or zirconium.

One embodiment provides that the chemical compound comprises a titanate and/or a zirconate.

The salts or esters of the titanium acids (HₓTi_{y}O_{z}, practically the different hydrates of titanium dioxide) are designated as titanates. These are preferably present in an especially organic complex. A zirconate is a zirconium comprising an oxyanion. According to the invention, this is also preferably present in an organic complex in particular.

One embodiment provides that the chemical compound comprises an isopropyl and/or a tri(dioctyl)phosphate chain.

The use of isopropyl triisostearoyl titanate, isopropyl tri(dioctyl)phosphate titanate, isopropyl tri (N-ethylenediamino) ethyl titanate and/or neopentyl(diallyl)oxy-tri(dioctyl)phosphate zirconate has proven to be particularly advantageous, the structural formulae of which can be shown as follows:

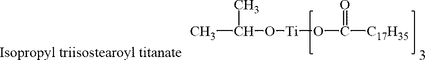

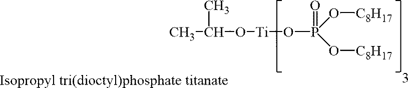

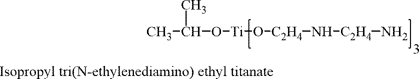

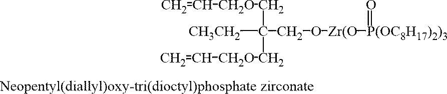

Thus, the use of the listed additives showed particularly good adhesion between housing bodies and containers, which have an untreated outer surface - i.e., in which the outer oxide layer has not been removed.

One embodiment provides that the field device is a flow meter, in particular a magnetic-inductive flow meter.

The method according to the invention for producing a housing for a field device, in particular a field device according to the invention, comprises the following method steps:
incorporating an additive into a first component or a second component, preferably into the second component of a potting material,
   wherein the first component comprises an isocyanate,
   wherein the second component comprises a polyol,
   wherein the additive comprises at least one chemical compound having an oxidized transition metal, preferably of the 4th subgroup;
mixing the individual components to form the potting material;
pouring the potting material into a potting mold,
   wherein the potting mold is disposed on an outer surface of a container; and
allowing the potting material to cure to form the composite material at a curing temperature.

It has been found that an admixture of the additive into the first component, i.e., into the isocyanate, leads to formation of an unpleasant odor. This problem can be solved by adding the additive into the second component.

The provision of an additive with a chemical compound having an oxidized transition metal leads to chemical compounds between the polymer matrix and the outer surface of the container and thus to a better adhesion. Furthermore, the additive conveys the reaction between the first component and the second component, so that heating of the composite material during formation of the housing body can be partially or even completely dispensed with. Thus, the composite material forms a so-called cold-casting system.

Advantageous embodiment of the invention are the subject matter of the dependent claims.

One embodiment provides that the curing temperature is less than 50° C., in particular less than 40° C. and preferably less than 30° C.

An advantage of the embodiment is that the processing of the housing body can take place at lower temperatures. In addition, the further processing of the automation field device can be started earlier, because the final curing is also achieved subsequently at room temperature.

One embodiment provides that the additive is present in the second component in a weight ratio of at least 0.3%, in particular at most 1% and preferably 0.4 to 0.5%.

One embodiment provides that the outer surface of the container is oxidized at a position provided for the housing.

Prior to further processing - e.g., welding with the second PE tube - the PE tubes are usually treated by corresponding pretreatment methods such as cleaning, (sand) blasting, flame treatment and/or plasma coating with subsequent primers. A so-called “oxide layer” of the PE tube must be peeled off, because otherwise sufficient adhesion cannot be ensured. However, this is extremely disadvantageous or even a hindrance for mass production of field devices or for curved outer surfaces of the container. The use of the above additive makes it possible to dispense with the removal of the oxide layer. If the removal of the oxide layer is dispensed with, the outer surface thus remains oxidized at a position provided for the housing.

One embodiment provides that the transition metal is selected from the group comprising titanium or zirconium.

Titanium or zirconium in the additive have particularly good catalytic properties and promote or initiate a chemical reaction between the outer surface of the container and the polymer matrix. It was shown that the chemical reaction is carried out even in the case of an oxidized PE tube.

One embodiment provides that the chemical compound comprises a titanate and/or a zirconate, and/or wherein the chemical compound comprises an isopropyl- and/or a tri(dioctyl) phosphate chain.

According to the invention, an additive comprising titanates and/or zirconates is used to improve the adhesion of a housing body formed from a polyurethane on a container.

According to one embodiment, the housing body has a Shore hardness of at least 60D, in particular of at least 70D and preferably of at least 85D (according to ISO 868 (version 2003)).

Shore hardness describes the mechanical resistance which prevents the potting material from mechanical penetration of another body and depends only to a limited extent on the strength of the body. The Shore hardness is a material characteristic value for elastomers and plastics and is defined in the standards DIN EN ISO 868, DIN ISO 7619-1 and ASTM D2240-00 (version 2018).

According to one embodiment, the housing (7) meets the requirements of the IP68 protection class (version 2020).

According to DIN EN 60529 (version 2020), the first identifier means that the housing is dust-tight and is thus protected against the ingress of foreign bodies. According to DIN EN 60529, the second identifier means that the interior of the housing is protected against ingress of water despite continuous submersion.

The IP protection class indicates the resistance of the housing of a field device to the ingress of foreign bodies and water. The two numbers of the protection class have the following meanings: The first number indicates how resistant the housing is against the ingress of foreign bodies. The second number indicates the leak-tightness with respect to water. A housing which meets the requirement of the IP68 protection class (version 2020) is thus dust-tight and protected against continuous immersion in water.

According to one embodiment, the reaction heat released by the reaction of the first component with the second component leads to a temperature increase of the composite material at an interface with the measuring component or with the container of less than 100° C., in particular less than 70° C. and preferably less than 30° C.

When electronic components are cast with components that react with one another and form a foam, it is particularly important that the reaction heat released does not damage the electronic components and/or the measuring components. This is important in particular when plastic parts, for example in the form of insulations, are installed in the electronic components or in the measuring components, or if heat-sensitive electronic components are installed. A coordination of the two components and the heat released during the chemical reaction is therefore essential. In order to avoid damage to the measuring components, the ambient conditions can be controlled in such a way that the reaction heat released is dissipated continuously and the composite material thus does not exceed a temperature rise or a temperature change of 100° C., 70° C. or 30° C. This is accomplished, for example, by the reaction taking place in a cooled-down environment or by the released heat being dissipated with a flowing medium, such as nitrogen, for example.

On the other hand, the reaction heat can already be influenced by the matching of the first and second components. According to the invention, a first component is selected with an isocyanate and a second component with a polyol. In this case, the reaction heat released is so low that the temperature rise remains below the aforementioned critical temperature change.

The polyurethanes used for the production of the housing are usually elastomeric plastics which are produced on the basis of a liquid multi-component system which is formed immediately before processing from reactive components, wherein the latter are introduced into the potting mold after being mixed together and allowed to cure there within a predeterminable reaction time. As is known, polyurethanes are prepared by the polyaddition process from di- and polyisocyanates with polyhydric alcohols. For example, prepolymers composed of aliphatic and/or aromatic ether groups and glycol and isocyanate groups which can react with the added polyhydric alcohol can serve as components here.

Usually transmitters or electronic displays are connected to the housing via an adapter. Therefore, respective adapters have to be manufactured and provided for measuring tubes having different tube diameters. According to the invention, the potting mold is shaped in such a way that the adapter, in particular the connections, are suitably concurrently cast. In addition, it is advantageous if the potting mold also assumes the shape of the adapter in places, which leads to an adapter forming after the potting. Its shape depends on the shape of the potting mold and can thus be adapted for the respective measuring tubes. Thus, an additional adapter can be dispensed with and the transmitter or the electronic display can be connected directly to the hardened potting material.

In the case of the potting mold, it is ideally possible to use conventional housing shells, known for example from DE 10 2012 110 665 A1. For a simple detachment of the potting mold from the potting material, the inner side of the potting mold has an anti-adhesive surface, or the potting mold is made of an anti-adhesive material. A coating with a grease or Teflon is particularly advantageous. The potting mold is usually produced using a die casting method. According to the invention, the potting mold is produced by means of a 3-D printing method. The sheathing can be produced, for example, from sheet metal or a plastics material, in particular designed to be reusable or as a “lost mold.”

Furthermore, the potting mold has an inlet so that the foaming potting material may be introduced in a simplified manner into the potting mold.

Components for forming a composite material from a potting material are generally not present in a homogenized state. For an ideal reaction condition, however, the respective component must be homogeneously distributed in the potting material. Only then can the formation of cavities and the detachment from the outer surface of the container be prevented.

The invention is explained in greater detail with reference to the following figures. The following are shown:

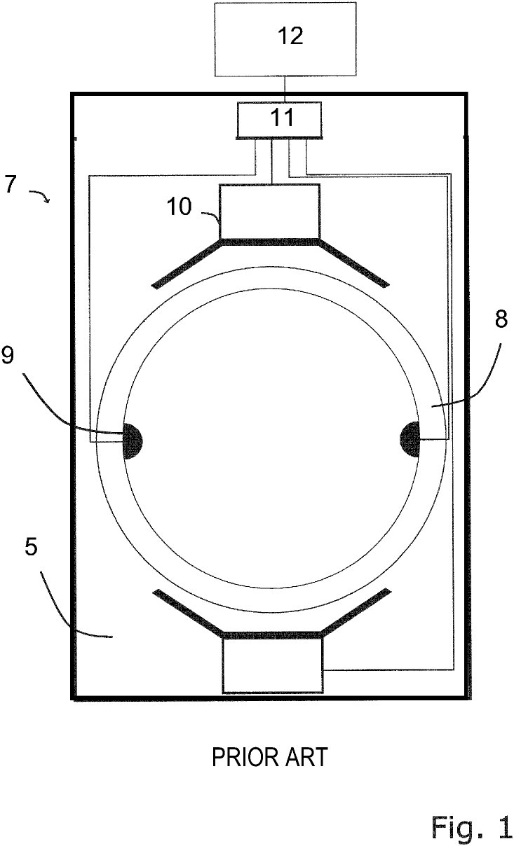

FIG. 1: a cross-sectional view of a magnetic-inductive flow meter according to the prior art;

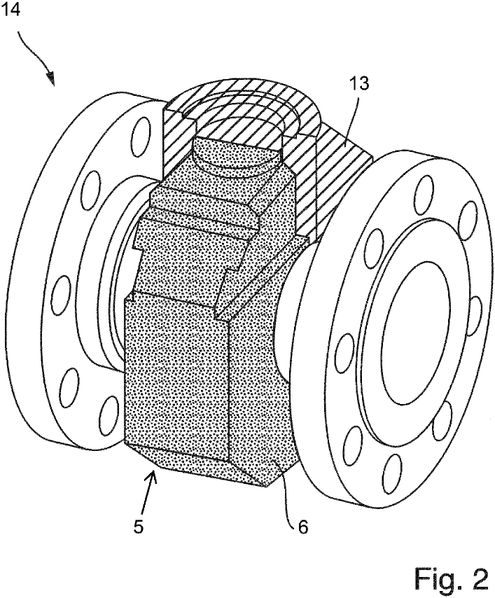

FIG. 2: a perspective view of an embodiment of the automation field device;

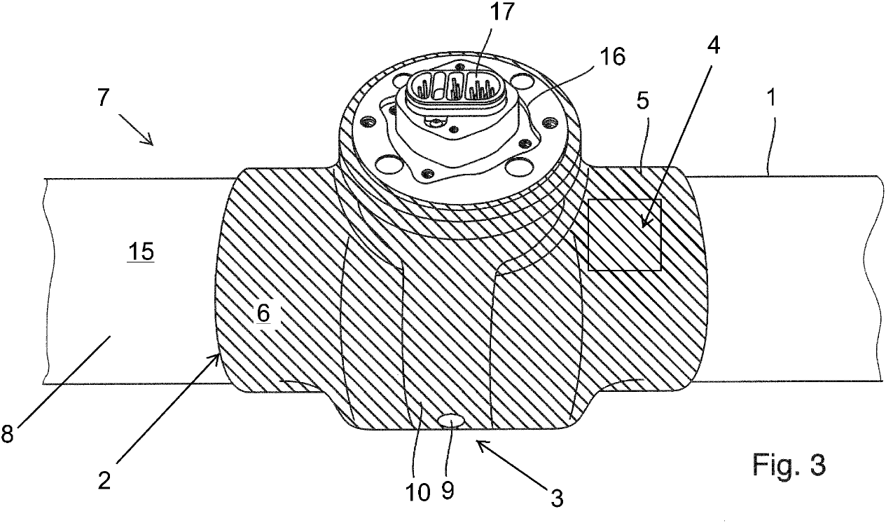

FIG. 3: a side view of a further embodiment of the automation field device; and

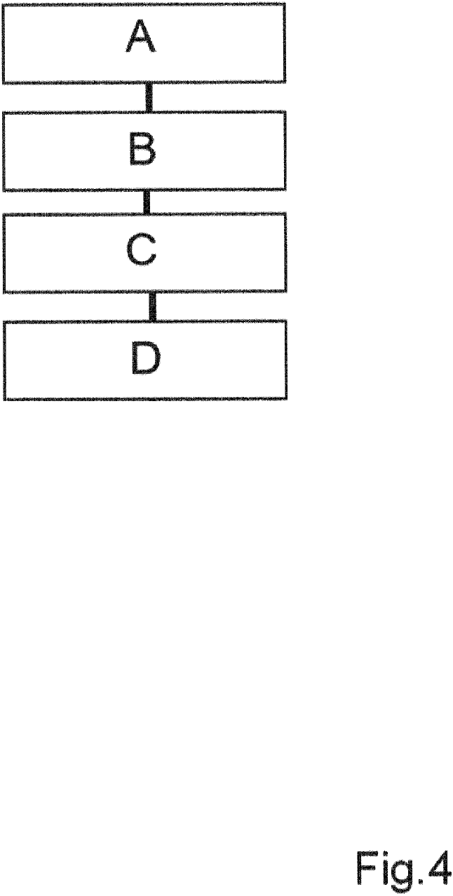

FIG. 4: a flow chart for describing the sequence of a method for producing the field device according to the invention.

An example of an automation field device is a magnetic-inductive flow meter 7 (see FIG. 1). The structure and measuring principle of the magnetic-inductive flow meter 7 is basically known. A flowable medium having an electrical conductivity is conducted through a measuring tube 8. A device 10 for generating a magnetic field is attached to the measuring tube 8, such that the magnetic field lines are oriented perpendicularly to a longitudinal direction defined by the measuring tube axis. A saddle coil or a pole shoe with a mounted coil is preferably suitable as device 10 for generating the magnetic field. In addition, the device 10 can have field guide bodies for generating the magnetic field. When the magnetic field is applied, a potential distribution is produced in the measuring tube 8 which is tapped with a device 9 for measuring an induced measurement voltage, in the case with two measuring electrodes attached to the inner wall of the measuring tube 8. As a rule, these are disposed diametrically and form an electrode axis, which runs perpendicular to an axis of symmetry of the magnetic field lines and the longitudinal axis of the tube. On the basis of the measured induced measurement voltage and taking into account the magnetic flux density, the flow rate of the medium can be determined and, taking into account the cross-sectional area of the tube, the volumetric flow rate can be determined. In order to prevent the measurement voltage applied to the measurement electrodes via the carrier tube of the measuring tube 8 from being dissipated, the inner surface of the carrier tube is lined with an insulating material or a plastic liner. The magnetic field produced by an electromagnet, for example, is generated by a clocked direct current alternating polarity by means of an operating circuit 11. This guarantees a stable zero point and renders the measuring resistant against influences from multiple phase substances, inhomogeneities in the liquid or low conductivity. A measurement and/or evaluation circuit 11 reads the measurement voltage applied to the measurement electrodes and determines the flow rate and/or the calculated volume flow rate of the medium. In the cross section shown in FIG. 1 of the magnetic-inductive flow meter, the measurement electrodes are in direct contact with the medium. However, coupling can also take place capacitively. The measuring apparatus and the electronic components of the magnetic-inductive flow meter are usually protected from external influences by a housing. A housing body formed from a potting material applied in liquid form and cured serves to stabilize the measuring arrangement - in the case of the device 10 for generating the magnetic field and the device 9 for measuring the induced measurement voltage - and the electronic components - the operation, measurement and/or evaluation circuit 11 - against mechanical and thermal influences.

FIG. 2 is a perspective view of an embodiment of an at least partly interconnected automation field device 14. A conventional housing shell, which forms a cavity between the housing shell wall and the outer surface of the container and is installed in field devices for protecting the electronic components, in which a subsequent access to the interior of the housing 5 is provided, was used as the potting mold 13. It can take any shape. A 3-D printing method is suitable for special shaping purposes. After the filling of the cavity formed by the potting mold 13 with a potting material, the potting mold 13 can be removed again, so that it can be used for the production of further housing bodies 6. A transmitter, which transmits the measurement signals to a display unit and is embedded in the housing body 6, in particular in the polymer matrix, is not visible in FIG. 2. The polymer matrix at least partly comprises a composite material which at least partly surrounds the measuring apparatus and the electronic components. The composite material comprises a polymer matrix and an additive, wherein the additive comprises at least one chemical compound having an oxidized transition metal, preferably of the 4th subgroup. The additive serves to form an improved adhesion between the outer surface of the container and the housing body 6. After the potting, the potting mold is removed and the housing body 6 made of the polymer composite assumes the function of the sheathing. Alternatively, the potting mold 13 is not removed. In this case, the polymer matrix primarily ensures the fixing of the electronic components. The outer housing sheathing takes over the stabilization and the protection of the measuring components. The container is a metallic measuring tube with flange connections.

FIG. 3 shows a side view of a further embodiment of a magnetic-inductive flow meter 7 having a cast adapter 16. During the pouring of the potting material, said adapter is introduced into the potting mold in such a way that the connections 17 remain free and only the end piece is encased with the potting material. In the illustrated embodiment, the adapter 16 is concurrently cast as a separate component. However, the adapter 16 does not necessarily have to be designed as a separate component. The housing body 5 or parts of the housing body can assume the shape of the adapter 16 through the selection of the potting mold. In this case, the electrical connections 17 are fixed to the potting mold during the pouring of the potting material and thus cast in such a way that the contact points of the connections 17 are not concurrently cast. The display unit can then be connected directly to the housing body 6, and an adapter as a separate component is therefore not necessary.

The magnetic-inductive flow meter 7 comprises a container 1, wherein the container 1 is a measuring tube 8 with a PE tube as a support tube 15. A housing 5 with a housing body 6 is disposed on the outer surface 2 of the measuring tube 8. The housing body 6 comprises a composite material at least in part. The measuring apparatus 3 and the electronic components 4 of the magnetic-inductive flow meter 7 are at least partly surrounded by the composite material. The composite material is a polymer matrix into which an additive is embedded. This serves to improve the adhesion between housing body 6 and outer surface 2 of measuring tube 8 in order to meet the requirement of the IP68 protection class. The additive is a chemical compound having comprising an oxidized transition metal, preferably of the 4th subgroup. Particularly good results were achieved with an additive having a titanate. The polymer matrix is a polyurethane polymer formed from a two-component system.

FIG. 4 shows a flow chart for describing the sequence of a method for producing the field device according to the invention. The method comprises process steps A to D:

A) incorporating an additive into a second component of a two-component potting material.

The potting material is a two-component system, but can also have further additives, such as fillers or dyes. The first component comprises an isocyanate and the second component comprises a polyol. The additive is a chemical compound having an oxidized transition metal. The transition metal is a titanium and/or a zirconium. In particular, the transition metal is present in the form of a titanate and/or a zirconate. In addition, the additive comprises a chemical compound with an isopropyl- and/or a tri(dioctyl)phosphate chain.

B) mixing the individual components to form the potting material.

C) pouring the potting material into a potting mold.

In this case, the potting mold is disposed on an outer surface of a container which is to be provided with a housing. In the present embodiment, the container is a polyethylene tube, PE tube for short, which is used primarily in pipeline systems for gas, water supply and waste water disposal and can be provided with a drinking water supply.

D) allowing the potting material to cure to form the composite material at a curing temperature.

Since the present potting material is a cold-casting potting, the curing temperature can be selected to be less than 50° C., in particular less than 40° C. and preferably less than 30° C. Since the potting material is also ready for further processing at curing temperatures of less than 30° C., even after a few hours - although the Shore hardness to be achieved is not yet reached - it is possible to allow the potting material to cure even at room temperature. The additive is present in the second component in a weight ratio of at least 0.3%, in particular at most 1% and preferably 0.4 to 0.5%.

An additional method step, in which the outer surface of the container is treated, can be dispensed with.

LIST OF REFERENCE SIGNS

| | |
|---|---|
| Container | 1 |
| Outer surface | 2 |
| Measuring apparatus | 3 |
| Electronic components | 4 |
| Housing | 5 |
| Housing body | 6 |
| Magnetic-inductive flow meter | 7 |
| Measuring tube | 8 |
| Device for measuring an induced measurement voltage | 9 |
| Device for generating a magnetic field | 10 |
| Operation, measurement and/or evaluation circuit | 11 |
| Display device | 12 |
| Potting mold | 13 |
| Automation field device | 14 |
| Carrier tube | 15 |
| Adapter | 16 |
| Connections | 17 |

1-15. (canceled)

16. A process automation field device, comprising:
a container configured to receive and/or conduct a medium to be measured, wherein the container includes an outer surface;
a measuring apparatus configured to determine a process variable of the medium;
electronic components configured to operate the measuring apparatus;
a housing configured to protect the measuring apparatus and the electronic components, the housing comprising a housing body, the housing body at least partly comprising a composite material, wherein the composite material comprises a polymer matrix and an additive, wherein:
the measuring apparatus and the electronic components are disposed in the housing;
the housing body is disposed on the outer surface;
the measuring apparatus and the electronic components are at least partly surrounded by the composite material; and
the additive comprises at least one chemical compound including an oxidized transition metal.

17. The field device of claim 1, wherein the transition metal of the oxidized transition metal is of the fourth subgroup of the periodic table.

18. The field device of claim 1, wherein the outer surface comprises a polyolefin.

19. The field device of claim 1, wherein the container is a polyethylene tube.

20. The field device of claim 1, wherein the polymer matrix comprises at least one first component and one second component, wherein the first component comprises an isocyanate, and wherein the second component comprises a polyol.

21. The field device of claim 1, wherein the transition metal is at least one of titanium and zirconium.

22. The field device of claim 1, wherein the at least one chemical compound comprises at least one of a titanate and a zirconate.

23. The field device of claim 22, wherein the at least one chemical compound comprises at least one of an isopropyl chain and a tri(dioctyl)phosphate chain.

24. The field device of claim 1, wherein the field device is a magnetic-inductive flow meter.

25. A method for producing a housing for a field device according to claim 1, the method comprising:
incorporating the additive into a first component or a second component of the polymer matrix, wherein the first component comprises an isocyanate, and wherein the second component comprises a polyol;
mixing the first and second components to form a potting material;
pouring the potting material into a potting mold, wherein the potting mold is arranged to at least partially surround the outer surface of the container; and
curing the potting material to form the composite material at a curing temperature, thereby forming the housing body.

26. The method of claim 25, wherein the additive is incorporated into the second component of the potting material.

27. The method of claim 25, wherein the transition metal of the oxidized transition metal is of the fourth subgroup of the periodic table.

28. The method of claim 25, wherein the curing temperature is less than 50° C.

29. The method of claim 25, wherein the curing temperature is less than 30° C.

30. The method of claim 25, wherein the additive is present in the second component in a weight ratio of at least 0.3% and at most 1%.

31. The method of claim 25, wherein the additive is present in the second component in a weight ratio of 0.4 to 0.5%.

32. The method of claim 25, wherein the outer surface is oxidized at a position at which the housing body is formed.

33. The method of claim 25, wherein the transition metal is at least one of titanium and zirconium.

34. The method of claim 25, wherein the additive comprises at least one of a titanate, a zirconate, an isopropyl chain and a tri(dioctyl)phosphate chain.

35. A method for producing a housing for a field device, the method comprising using an additive comprising at least one of a titanate compound and a zirconate compound as to improve adhesion of a housing body of the housing to a container on which the field device is disposed, wherein the housing body is formed of a polyurethane.
